(19) United States
(12) Patent Application Publication
(10) Pub. No.: US 2011/0087650 A1
(43) Pub. Date: Apr. 14, 2011

(54) CREATION AND USE OF CAUSAL RELATIONSHIP MODELS IN BUILDING MANAGEMENT SYSTEMS AND APPLICATIONS

(75) Inventors: Douglas P. Mackay, Los Angeles, CA (US); Gheorghe L. Vacariuc, Arnold, MO (US)

(73) Assignee: Johnson Controls Technology Company

(21) Appl. No.: 12/898,589

(22) Filed: Oct. 5, 2010

Related U.S. Application Data
(60) Provisional application No. 61/249,191, filed on Oct. 6, 2009.

(51) Int. Cl. G06F 17/30

(52) U.S. Cl. 707/722; 707/803; 707/769; 707/805; 707/E17.055; 707/E17.048; 707/E17.014

(57) ABSTRACT

A computing system for organizing and using information in a building management system (BMS) is shown and described. The computing system includes a memory device storing software defined building objects. The computing system further includes a processing circuit configured to relate the software defined building objects by causal relationships between the devices and to store the causal relationships and a description of the causal relationships in the memory device.

### CROSS-REFERENCE TO RELATED APPLICATIONS

The present application claims the benefit of U.S. Provisional Application No. 61/249,191, filed Oct. 6, 2009, the entirety of which is hereby incorporated by reference.

### BACKGROUND

The present invention relates generally to the field of building management systems.

A building management system (BMS) is, in general, a system of devices configured to control, monitor, and manage equipment in or around a building or building area. A BMS can include a heating, ventilation, and air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may include METASYS building controllers or other devices sold by Johnson Controls, Inc., as well as building devices and components from other sources.

A BMS may include one or more computer systems (e.g., servers, BMS controllers, etc.) that serve as enterprise level controllers, application or data servers, head nodes, master controllers, or field controllers for the BMS. Such computer systems may communicate with multiple downstream building systems or subsystems (e.g., an HVAC system, a security system, etc.) according to like or disparate protocols (e.g., LON, BACnet, etc.). The computer systems may also provide one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with the BMS, its subsystems, and devices.

### SUMMARY

One embodiment of the present invention relates to a computerized method for organizing and using information in a building management system (BMS). The method includes identifying a plurality of objects comprising building devices, software defined building objects, and other inputs to the BMS that affect a building environment. The method also includes identifying causal relationships between the identified objects and relating the identified objects by the causal relationships. The method further includes describing the causal relationships. The method yet further includes storing the causal relationships and descriptions in a memory device of the BMS.

Another embodiment of the present invention relates to a computer system for organizing and using information in a BMS. The computer system includes a memory device storing software defined building objects. The computer system also includes a processing circuit configured to relate the software defined building objects by causal relationships between the devices and to store the causal relationships and a description of the causal relationships in the memory device.

Yet another embodiment of the present invention relates to computer readable media with computer-executable instructions embodied thereon that, when executed by a computing system, perform a method for organizing and using information in a BMS. The media includes instructions for identifying a plurality of objects comprising building devices, software defined building objects, and other inputs to the BMS that affect the building environment. The media also includes instructions for identifying causal relationships between the gathered objects and includes instructions for relating the gathered objects by the causal relationships. The media further includes instructions for describing the causal relationships. The media yet further includes instructions for storing the causal relationships and descriptions in a memory device of the BMS.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1A is a perspective view of a building including a BMS, according to an exemplary embodiment;

FIG. 1B is a block diagram of the BMS for the building of FIG. 1A, according to an exemplary embodiment;

FIGS. 1C-D are detailed block diagrams of a portion of the BMS shown in FIG. 1B, according to an exemplary embodiment;

FIGS. 2A-B are diagrams of causal relationship models, according to an exemplary embodiment;

FIG. 3 is a flow diagram of a process for building a causal relationship model of the BMS, according to an exemplary embodiment;

FIG. 4 is a flow diagram of a process for using a hierarchical model of the BMS, according to an exemplary embodiment;

FIG. 5 is a flow diagram of a process for providing a graphical user interface that allows users to view or interact with a causal relationship model, according to an exemplary embodiment; and

FIG. 6 is a block diagram of the query engine shown in FIGS. 1C and 1D, according to an exemplary embodiment.

### DETAILED DESCRIPTION

Before turning to the figures, which illustrate the exemplary embodiments in detail, it should be understood that the disclosure is not limited to the details or methodology set forth in the description or illustrated in the figures. It should also be understood that the terminology is for the purpose of description only and should not be regarded as limiting.

Embodiments of the present disclosure include a computer system for a BMS (e.g., a BMS controller) that has been configured to help make differences in building subsystems transparent at the human-machine interface, application, or client interface level. The computer system is configured to provide access to different building devices and building subsystems using common or unified building objects (e.g., software objects stored in memory) to provide the transparency. In an exemplary embodiment, a software defined building object (e.g., “virtual building object,” “virtual device”) groups multiple properties from disparate building systems and devices into a single software object that is stored in memory and provided by a computer system for interaction with other systems or applications (e.g., front-end applications, control applications, remote applications, client applications, local processes, etc.). Multiple software defined building objects may be described as forming an abstraction layer of a BMS software framework or architecture. Benefits such as allowing developers to write applications that will work regardless of a particular building subsystem makeup (e.g., particular naming conventions, particular protocols, etc.) may be provided by such software defined building objects. Such software defined building objects are further described in Ser. No. 12/887,390, filed Sep. 21, 2010 to Huneycutt et al. application Ser. No. 12/887,390 is hereby incorporated by reference in its entirety.

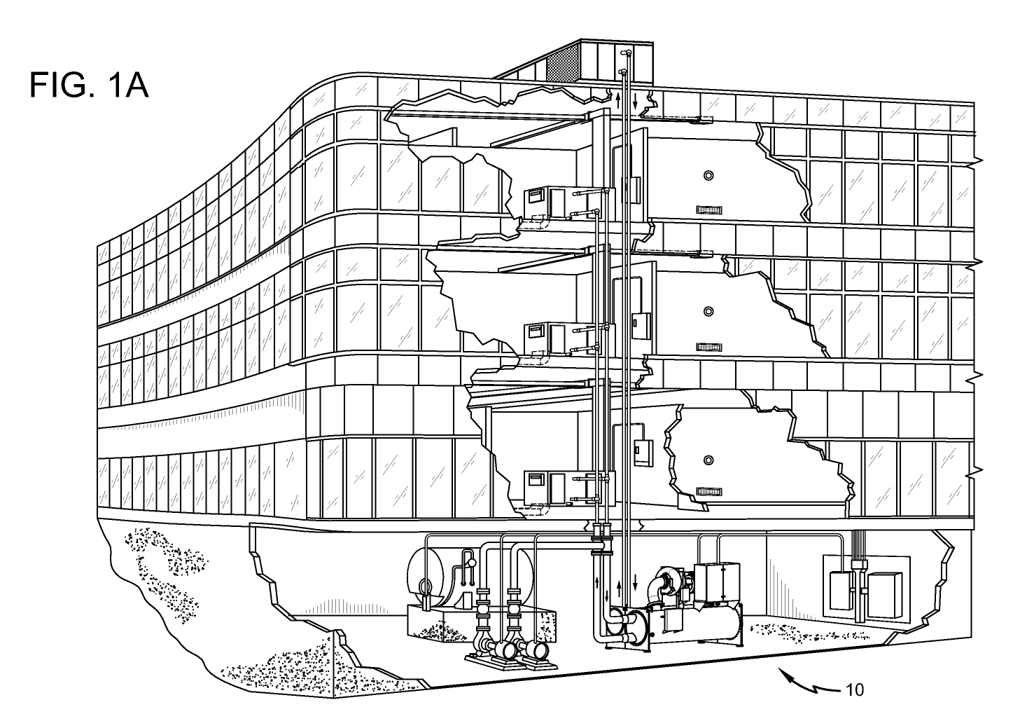

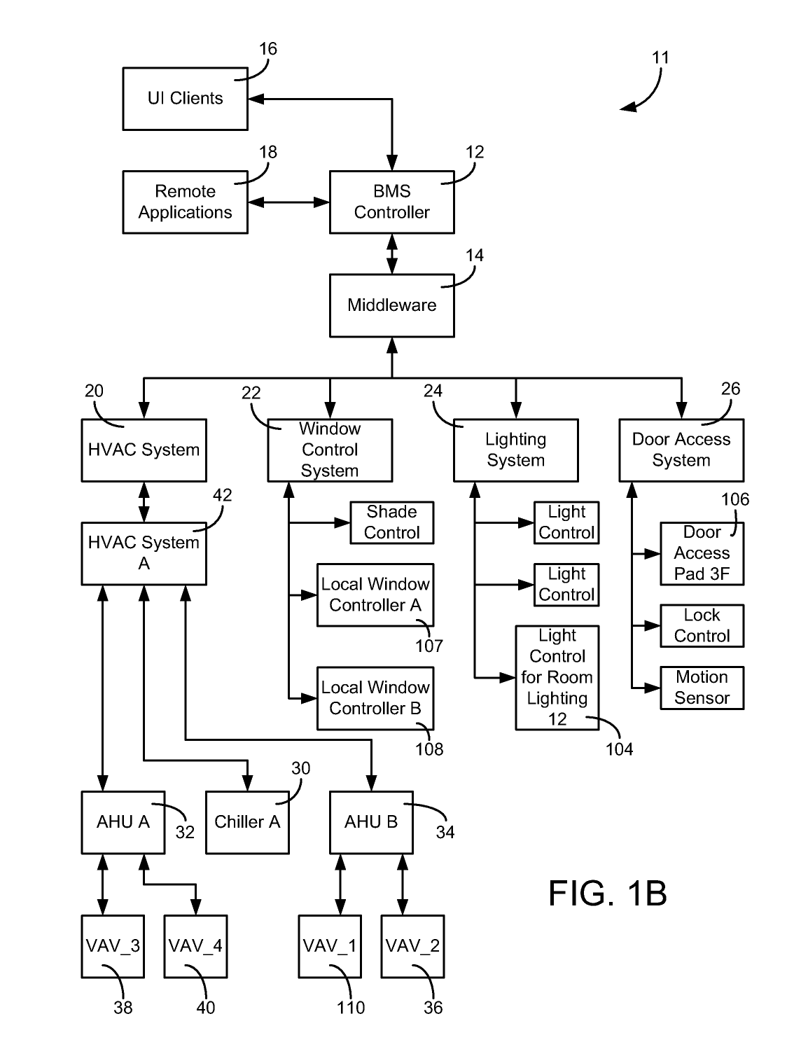

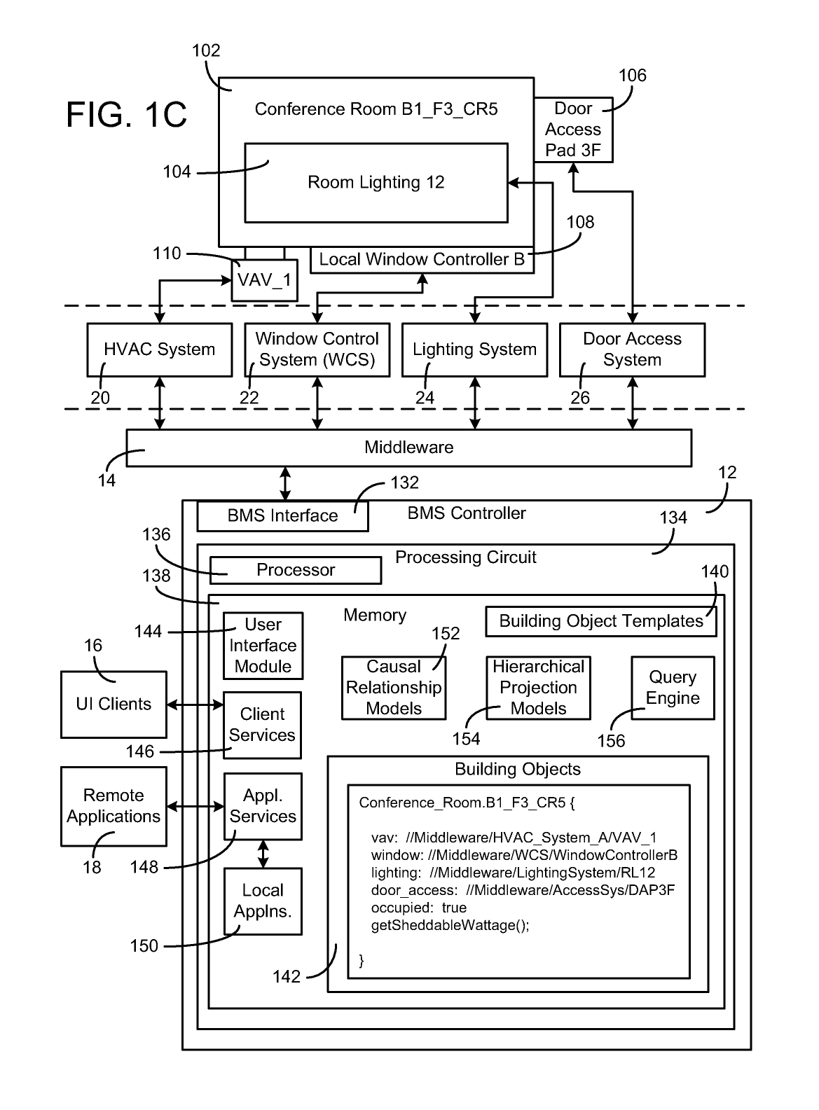

Referring now to FIG. 1A, a perspective view of a building 10 is shown, according to an exemplary embodiment. A BMS serves building 10. The BMS for building 10 may include any number or type of devices that serve the building. For example, each floor may include one or more security devices, video surveillance cameras, fire detectors, smoke detectors, lighting systems, HVAC systems, or other building systems or devices. In modern BMSs, BMS devices can exist on different networks within the building (e.g., one or more wireless networks, one or more wired networks, etc.) and yet serve the same building space or control loop. For example, BMS devices may be connected to different communications networks or field controllers even if the devices serve the same area (e.g., floor, conference room, building zone, tenant area, etc.) or purpose (e.g., security, ventilation, cooling, heating, etc.).

Referring now to FIG. 1B, a block diagram of an exemplary BMS 11 for building 10 of FIG. 1A is shown, according to an exemplary embodiment. BMS 11 is shown to include a plurality of BMS subsystems 20-26. Each BMS subsystem 20-26 is connected to a plurality of BMS devices and makes data points for varying connected devices available to upstream BMS controller 12. Additionally, BMS subsystems 20-26 may encompass other lower-level subsystems. For example, an HVAC system may be broken down further as “HVAC system A,” “HVAC system B,” etc. In some buildings, multiple HVAC systems or subsystems may exist in parallel and may not be a part of the same HVAC system 20.

As illustrated in FIG. 1B, a BMS subsystem includes HVAC system 20. HVAC system 20 is shown to include a lower-level HVAC system 42, named “HVAC system A.” For example, HVAC system 20 may control HVAC operations for a given building (e.g., building 10), while “HVAC system A” 42 controls HVAC operations for a specific floor of that building. “HVAC system A” 42 is connected to air handling units (AHUs) 32, 34, named “AHU A” and “AHU B” in the BMS, respectively. AHU 32 may control variable air volume (VAV) boxes 38, 40, named “VAV_{—}3” and “VAV_{—}4” in the BMS. Likewise, AHU 34 may control VAV boxes 36 and 110, named “VAV_{—}2” and “VAV_{—}1.” HVAC system 42 may also include chiller 30, named “Chiller A” in the BMS. Chiller 30 may provide chilled fluid to AHU 32 and/or to AHU 34.

HVAC system 42 may also receive data from AHUs 32, 34 (e.g., a temperature setpoint, a damper position, temperature sensor readings). HVAC system 42 may then provide such BMS inputs up to HVAC system 20 and on to middleware 14 and BMS controller 12. Similarly, other BMS subsystems may receive inputs from other building devices or objects and provide them to middleware 14 and BMS controller 12 (e.g., via middleware 14). For example, a window control system 22 may receive shade control information from one or more shade controls, may receive ambient light level information from one or more light sensors, or may receive other BMS inputs (e.g., sensor information, setpoint information, current state information, etc.) from downstream devices. Window control system 22 may include window controllers 107, 108, named “local window controller A” and “local window controller B” in the BMS, respectively. Window controllers 107, 108 control the operation of subsets of the window control system 22. For example, window controller 108 may control window blind or shade operations for a given room, floor, or building in the BMS. Lighting system 24 may receive lighting related information from a plurality of downstream light controls, for example, from room lighting 104. Door access system 26 may receive lock control, motion, state, or other door related information from a plurality of downstream door controls. Door access system 26 is shown to include door access pad 106, named “Door Access Pad 3F” which may grant or deny access to a building space (e.g., floor, conference room, office, etc.) based on whether valid user credentials are scanned or entered (e.g., via a keypad, via a badge-scanning pad, etc.).

BMS subsystems 20-26 are shown as connected to BMS controller 12 via middleware 14 and are configured to provide BMS controller 12 with BMS inputs from the various BMS subsystems 20-26 and their varying downstream devices. BMS controller 12 is configured to make differences in building subsystems transparent at the human-machine interface or client interface level (e.g., for connected or hosted user interface (UI) clients 16, remote applications 18, etc.). BMS controller 12 is configured to describe or model different building devices and building subsystems using common or unified building objects (e.g., software objects stored in memory) to help provide the transparency. Benefits such as allowing developers to write applications that will work regardless of the building subsystem makeup may be provided by such software building objects.

FIGS. 1C-D are detailed block diagrams of a portion of the BMS as shown in FIG. 1B, according to an exemplary embodiment. Many different building devices connected to many different BMS subsystems are shown to affect conference room “B1_F3_CR5.” For example, conference room 102 includes or is otherwise affected by VAV box 110, window controller 108 (e.g., a blind controller), a system of lights 104 named “Room Lighting 12,” and door access pad 106. As is viewable in FIGS. 1C-D and also in FIG. 1B, VAV box 110, window controller 108, lights 104, and door access pad 106 are not otherwise related. Each of the building devices shown at the top of FIGS. 1C-D may include local control circuitry configured to provide signals to their supervisory controllers or more generally to the BMS subsystems 20-26. The local control circuitry of the building devices shown at the top of FIGS. 1C-D may also be configured to receive and respond to control signals, commands, setpoints, or other data from their supervisory controllers. The local control circuitry of VAV box 110 may include circuitry that affects an actuator in response to control signals received from a field controller that is a part of HVAC system 20. Window controller 108 may include circuitry that affects windows or blinds in response to control signals received from a field controller that is part of window control system (WCS) 22. “Room Lighting 12”104 may include circuitry that affects the lighting in response to control signals received from a field controller that is part of lighting system 24. Access pad 106 may include circuitry that affects door access (e.g., locking or unlocking the door) in response to control signals received from a field controller that is part of door access system 26.

In conventional buildings, the BMS subsystems are often managed separately. Even in BMSs where a unified graphical user interface is provided, a user must typically click through a hierarchy such as is shown in FIG. 1B to view data points for a lower level device or to make changes (e.g., setpoint adjustments, etc.). Such separate management can be particularly true if the subsystems are from different manufacturers or communicate according to different protocols. Conventional control software in such buildings is sometimes custom written to account for the particular differences in subsystems, protocols, and the like. Custom conversions and accompanying software is time consuming and expensive for end-users or their consultants to develop. A software defined building object of the present disclosure is intended to group otherwise ungrouped or unassociated devices so that the group may be addressed or handled by applications together and in a consistent manner.

In an exemplary BMS controller, a conference room building object may be created in memory for each conference room in the building. Further, each conference room building object may include the same attribute, property, and/or method names as those shown in FIGS. 1C-D. For example, each conference room may include a variable air volume box attribute, a window attribute, a lighting attribute, and a door access device attribute. Such an architecture and collection of building objects is intended to allow developers to create common code for use in buildings regardless of the type, protocol, or configuration of the underlying BMS subsystems. For example, a single automated control application may be developed to restrict ventilation to conference rooms when the conference rooms are not in use (e.g., when the occupied attribute is equal to “true”). Assuming proper middleware and communications systems, the setup or the installation of a different BMS device or an application for a different BMS may not need to involve a re-write of the application code. Instead, for example, if a new building area is designated as a conference room, a new conference room building object can be created and set-up (e.g., a variable air volume unit mapped to the conference room building object). Once a new conference room building object is created and set-up, code written for controlling or monitoring conference rooms can interact with the new conference room (and its actual BMS devices) without modification.

Referring still to FIGS. 1C-D, the BMS is shown to include a BMS interface 132 in communication with middleware 14 of the BMS. Middleware 14 is generally a set of services that allow interoperable communication to, from, or between disparate BMS subsystems 20-26 of the BMS (e.g., HVAC systems from different manufacturers, HVAC systems that communicate according to different protocols, security/fire systems, IT resources, door access systems, etc.). Middleware 14 may be, for example, an EnNet server sold by Johnson Controls, Inc. While middleware 14 is shown as separate from BMS controller 12, in various exemplary embodiments, middleware 14 and BMS controller 12 are integrated. For example, middleware 14 may be a part of BMS controller 12.

BMS interface 132 (e.g., a communications interface) can be or include wired or wireless interfaces (e.g., jacks, antennas, transmitters, receivers, transceivers, wire terminals, etc.) for conducting data communications with another system or network. For example, BMS interface 132 can include an Ethernet card and port for sending and receiving data via an Ethernet-based communications network. In another example, BMS interface 132 includes a WiFi transceiver for communicating via a wireless communications network. BMS interface 132 may be configured to communicate via local area networks or wide area networks (e.g., the Internet, a building WAN, etc.). BMS interface 132 is configured to receive building management inputs from middleware 14 or directly from one or more BMS subsystems 20-26. BMS interface 132 can include any number of software buffers, queues, listeners, filters, translators, or other communications-supporting services.

BMS controller 12 is further shown to include a processing circuit 134 including a processor 136 and memory 138. Processor 136 may be a general purpose or specific purpose processor, an application specific integrated circuit (ASIC), one or more field programmable gate arrays (FPGAs), a group of processing components, or other suitable processing components. Processor 136 is configured to execute computer code or instructions stored in memory 138 or received from other computer readable media (e.g., CDROM, network storage, a remote server, etc.). According to an exemplary embodiment, memory 138 is communicably connected to processor 136 via electronics circuitry. Memory 138 (e.g., memory unit, memory device, storage device, etc.) is one or more devices for storing data and/or computer code for completing and/or facilitating the various processes described in the present disclosure. Memory 138 may be RAM, hard drive storage, temporary storage, non-volatile memory, flash memory, optical memory, or any other suitable memory for storing software objects and/or computer instructions. Memory 138 may include database components, object code components, script components, or any other type of information structure for supporting the various activities and information structures described in the present disclosure. Memory 138, for example, includes computer code for executing (e.g., by processor 136) one or more processes described herein. When processor 136 executes instructions stored in memory 138 for completing the various activities described herein, processor 136 generally configures BMS controller 12 and more particularly processing circuit 134 to complete such activities.

Memory 138 is shown to include building objects 142 and building object templates 140, which can be used to construct building objects of predefined types. For example, building object templates 140 may contain a “Conference Room” template that can be used to define conference room objects in building objects 142.

In FIG. 1C, software defined building object 142 named “Conference_Room.B1_F3_CR5” is illustrated as existing within memory 138 of BMS controller 12. To create a particular building object (for example, a software object of an AHU), inputs from building management resources may be mapped (e.g., linked, associated, described, grouped) to attributes of the particular building object. A simplified exemplary result of such mapping might be an object such as:

```
Floor1AHU {
  temperature_sensor: Floor1AHU.controllerB.TempS;
  setpoint: Floor1AHU.345server.Setpoint;
  damper_position: Floor1AHU.345server.Damper;
}
```

The building object's name is “Floor1AHU” which may conform to a naming convention indicating that it is the AHU serving the first floor of a building. The building object “Floor1AHU” has three values or attributes: temperature_sensor, setpoint, and damper_position that are mapped to the particular BMS resources of “Floor1AHU.controllerB.TempS,” “Floor1AHU.345server.Setpoint,” and “Floor1AHU.345server.Damper,” respectively. The mapping provides a description for BMS or computing resources (e.g., back end software applications or client applications) so that the BMS or computing resources can identify, access, display, change, or otherwise interact with the particular BMS resources mapped to “Floor1AHU” even when the resources are associated with different servers or controllers.

For example, BMS controller 12 may group inputs from the various subsystems 20-26 to create a building object “Conference_Room.B1_F3_CR5” including inputs from various systems controlling the environment in the room.

An exemplary software defined building object might be an object such as:

```
Conference_Room.B1_F3_CR5 {
  vav: //Middleware/HVAC_System_A/VAV_1;
  window: //Middleware/WCS/WindowControllerB;
  lighting: //Middleware/LightingSystem/RL12;
  door_access: //Middleware/AccessSys/DAP3F;
  occupied: true;
  getSheddableWattage( );
}
```

The software defined building object's name is “Conference_Room.B1_F3_CR5” which may conform to a naming convention indicating that it is a conference room in a particular location in the building, e.g. Conference Room 5 is on Floor 3 of Building 1. The building object “Conference_Room.B1_F3_CR5” has several values or attributes including vav, window, lighting, door_access, occupied, and getSheddableWattage. The attributes of vav, window, lighting, and door_access are mapped to the particular BMS resources of “HVAC_System_A/VAV_1,” “WCS/WindowControllerB,” “LightingSystem/RL12,” and “AccessSys/DAP3F,” respectively. The mapping provides a description for BMS or computing resources (e.g., back end software applications, client applications, BMS control routines, etc.) so that the BMS or other computing resources can identify, access, display, change or otherwise interact with the software defined building object in a meaningful way (e.g., in a way that allows changes to be made to the mapped devices). A software defined building object may be mapped to BMS inputs manually. For example, the mapping may be completed by a user with a graphical user interface tool that requires a user to either type in or “drag and drop” BMS inputs to an object. Software defined building objects may also or alternatively be mapped to BMS inputs by computerized systems configured to provide varying degrees of mapping automation. For example, patent application Ser. No. 12/887,390, filed Sep. 21, 2010 and incorporated herein by reference in its entirety, describes systems and methods for creating software defined building objects and mapping BMS inputs to the building objects. “Occupied” is a boolean property unique to the “Conference_Room.B1_F3_CR5” building object. GetSheddableWattage( ) is a method unique to the “Conference_Room.B1_F3_CR5” building object.

As an example of how a building object may be used by the system, all conference room building objects may have the same attributes as “Conference_Room.B1_F3 CR5” listed above. Once each of the conference rooms in building 10 are mapped to a software defined conference room building object, the rooms may be treated the same way in code existing in BMS controller 12, remote applications 18, or UI clients 16. Accordingly, an engineer writing software code for UI clients 16, remote applications 18 or BMS controller 12 can know that each conference room will have attributes listed above (e.g., VAV, window, lighting, door access, occupied, getSheddableWattage( ). Therefore, for example, rather than having to know an address for a particular variable air volume controller in a particular HVAC system, a given conference room's VAV controller may be available at the conference room's vav attribute.

The creation of a software defined building object may include three steps:

1. defining a building object template;

2. creating an instance of a building object based on the template; and

3. mapping or binding building object properties or attributes to particular BMS devices or inputs.

As an example of the first step, a conference room template or class may be created (e.g., by a developer, by a rapid application development module, etc.) such as the following:

```
public class Conference_Room extends Device {
  def vav
  def window
  def lighting
  def door_access
  def occupied
  def getSheddableWattage( ) { ... }
}
```

In some embodiments, the building object template or class may be a Groovy/Java class configured to inherit a series of benefits such as the ability to extend existing devices.

An instance of the class may be created and named (for example “B1_F3_CR5”). The names can be descriptive, based on an automated routine configured to find building objects, manually applied, or otherwise.

The mapping or binding process maps disparate BMS devices or inputs to the instance of the building object.

Once the building objects are created and BMS devices or inputs are mapped to the building objects, software defined building objects may be used by applications (local, remote, client, etc.) with any suitable programming language or syntax. As an example of interaction with the software defined building object used in previous examples, the following exemplary piece of code is configured to load “B1_F3_CR5” as ConfRoom, print the result of the method getSheddableWattage for ConfRoom, and set the window parameter to “50” (which may be sent to WCS 22 or “Local Window Controller B” 108 via BMS interface 132 or middleware 14 shown in FIGS. 1C-D to cause the blinds to be 50 percent open) when the ConfRoom object is saved.

def ConfRoom=factory.load(“Conference_Room.B1_F3_CR5”)

printIn ConfRoom.getSheddableWattage( );

ConfRoom1.window=50

factory.save(ConfRoom)

In an exemplary embodiment, application services 148 of BMS controller 12 shown in FIGS. 1C-D may be or include web services configured to allow remote applications 18 or local applications 150 to access building object templates 140, building objects 142, causal relationship models 152, hierarchical projection models 154 and query engine 156 directly or indirectly via a set of internet application programming interfaces. To support such interfaces, each software defined building object may include or be exposed to a toXML( )method configured to describe the software defined building object using XML. In another exemplary embodiment, application services 148 allows remote applications 18 on other BMS controllers to communicate with BMS controller 12 over a network.

Conventional building systems do not include organizational models which link and describe building objects by causal relationships (e.g., “ontological models”). Memory 138 is shown to include causal relationship models 152, which store the causal relationships between objects in building objects 142. For example, a “ventilates” causal relationship may be used to relate a VAV box object to a conference room object.

In FIG. 1D, causal relationship models 152 is shown to include a causal relationship model for conference room 102 and a number of building objects (e.g. building objects 30, 32, 40, etc. associated with devices shown in FIG. 1B) that affect access to conference room 102 or the environment of conference room 102. The causal relationships from these building objects to conference room 102 are identified and mapped back to conference room 102. For example, VAV box 110 is shown linked to conference room 102 with a directional link described by the name or tag “ventilates.” This link represent the causal relationship between VAV box 110 and conference room 102. More particularly, the link identifies the causal relationship between VAV box 110 and conference room 102 as one where VAV box 110 provides ventilation to conference room 102. VAV box 110 is affected by HVAC System 20 and so the corresponding causal relationship is shown as being directional from conference room 102 to VAV box 110 with “controls” describing the relationship. Similarly, room lighting 104 lights conference room 102, window controller 108 dims conference room 102, and access pad 106 controls access to conference room 102. As described above, conference room 102 is not a building device that is associated with any one particular controller or BMS subsystem. As a complement to the software defined building object for the conference room, the exemplary causal relationship information structure shown at the bottom of FIG. 1D provides a multi-level relationship map that more clearly represents the complex control environment of the actual conference room shown at the top of FIG. 1D. In addition to more coding and software development advantages, the causal relationship models can provide new user interface views, more robust searching “show me all VAV boxes that ventilate conference rooms,” new fault detection and diagnostics tools, and other advantages.

Conventional building systems do not include organizational models which link and describe building objects by causal relationships (e.g., “ontological models”). A key feature of an ontological model is the ability to define relationships between dissimilar object types. A conventional hierarchical model may have an HVAC server object and a “VAV box” that is a member of the HVAC server object due to its control connection. Such a hierarchical model allows objects to be handled in a hierarchical manner, but lacks the ability to interrelate objects that do not follow the chain of inheritance. Causal relationships or ontological models, however, allow dissimilar objects to be related, thereby adding layers of description, flexibility, and robustness to the system. For example, a “ventilates” causal relationship may be used to relate a VAV box object to a conference room object, even though VAV box objects and conference room objects are dissimilar. Memory 138 is shown to include causal relationship models 152, which store the causal relationships between objects in building objects 142.

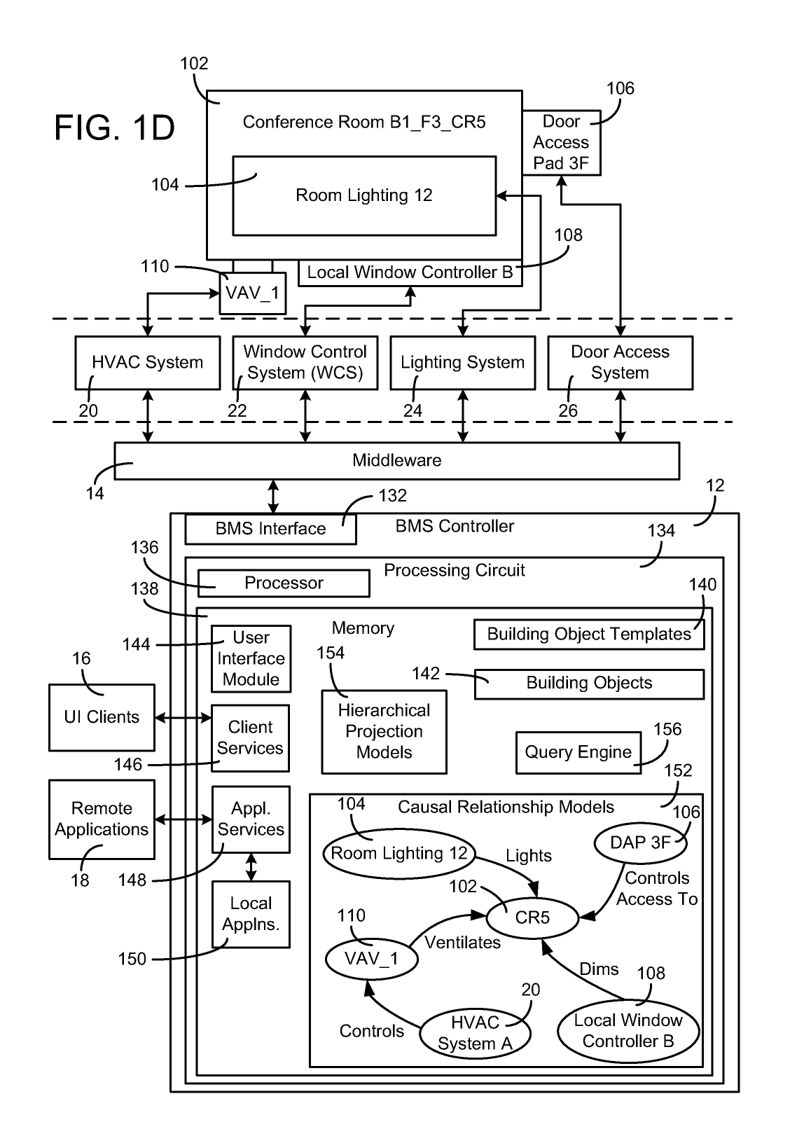

FIGS. 2A-B, illustrate two exemplary causal relationship models. In FIG. 2A, causal relationships are shown between various building objects. Building object 210, named “Building 1” in the BMS, has causal relationships with chiller 30 and floor 214, named “Floor 3.” The causal relationship “has” is shown to link and define the relationships between building 210, floor 214 and chiller 30. Chiller 30, in turn, has causal relationships with AHUs 32, 34, i.e. it “chills” the air passing through AHUs 32, 34. AHU 32, in turn, has a causal relationship, “controls,” with VAV boxes 38, 40. Similarly, AHU 34 has a causal relationship, “controls,” with VAV boxes 36, 110. Likewise, VAV boxes 38, 40 have “ventilates” causal relationships with conference room 212, named “Conference Room 4” or “CR4” in the BMS. Similarly, VAV boxes 36, 110 have “ventilates” causal relationships with conference room 102, named “Conference Room 5” or “CR5” in the BMS. CR5 102 is shown to have properties 216, which can be created by default when a new conference room object is added to the BMS, or created by the BMS or a user when more information about the conference room becomes available. Finally, conference rooms 102, 212 are shown to have causal relationships with floor 214, denoting that both rooms are “on” floor 3. As is illustrated with conference room CR5, a software defined building object can be causally related with one or more actual devices (e.g., VAV_1) or with other software defined building objects (e.g., “Floor 3”).

Causal relationship models may be stored in memory in any number of ways. In one embodiment, causal relationship models may be stored within one or more tables. For example, a table may have columns for a relationship type (e.g., a relationship description), a first object identifier, and a second object identifier. With reference to FIG. 2A, a row entry in such a table may include “has” in the relationship column, “Building 1” in the first object identifier column, and “Floor 3” in the second object identifier column. In this way, the causal relationship models 152 can be easily queried by relationship type, first object identifier and/or second object identifier. In another embodiment, a different table can be established for every type of causal relationship in the system. For example, a “controls” table may be established with a “source identifier” field and a “destination identifier” field. Referring to FIG. 2A, in a row for such a table “AHU B” would populate the “source identifier” field and “VAV_2” would populate the “destination identifier” field. In other embodiment, each software-defined building object may include a number of causal relationship properties or attributes that store the causal relationships. For example, a building object for “CR 4” shown in FIG. 2A might include a “ventilated by” property that is a delimited string of devices that ventilate CR 4 (e.g., ventilated by: VAV_3, VAV_4). Any number of suitable information structures for representing the causal relationship may be stored in memory.

FIG. 2B illustrates another exemplary causal relationship model for the building objects in FIG. 2A. In FIG. 2B, causal relationships between building objects are linked with causal relationships that have a directionality that is opposite to that shown in FIG. 2A. The causal relationship model of FIG. 2B may co-exist with the model shown in FIG. 2A. In other embodiments, only one of FIG. 2A and FIG. 2B will exist for a BMS. A set-up process may prompt a user for whether a “top-down” or “bottom-up” directionality is desired. In some embodiments the causal relationship model will be maintained and stored on a “bottom-up” basis such as that shown in FIG. 2B. In a system where the causal relationship models of FIG. 2A and FIG. 2B co-exist, FIG. 2A's causal relationship “has” that links building 210 to chiller 30 in FIG. 2A may have a corresponding causal relationship “in” that links chiller 30 to building 210 in FIG. 2B.

Causal relationship models such as those shown in FIGS. 2A-B may be created in different ways according to varying embodiments of the invention. In some embodiments, for example, a user may be prompted to create, or an automated system may create, a model with immediate references to particular building objects. In other embodiments, the system may prompt or otherwise allow a user to define causal relationship classes or templates of causal relationship models that will later be used and reused for particular instances of causal relationship models and objects.

In an exemplary embodiment, a specification of a class, class relationships, and properties can be defined generally as a template. For example, a template for an HVAC class may include default causal relations to equipment objects, such as VAV boxes, and to location objects, such as a floor or building. The representation of the class may be in the form of a directed graph (regardless of the underlying information structure) and not a conventional device tree form. Default properties or attributes may be established for one or more of the nodes. Instantiated objects can then be created or mapped using the relational template. The created causal relationship models may be modified at run-time or via a tool that allows modification outside of a run-time environment. For example, a tool may be provided for adding, modifying, or removing relationships, objects, classes, properties, attributes, and the like. When edits are made, the computing system or tool may be configured to dynamically adjust the model's structure (e.g., as the model is not stored as a static tree hierarchy). For example, if access pad 106 is no longer used to control access to conference room 102, the causal relationships pointing to access pad 106 may be deleted as well as its corresponding building object—but the rest of the model remains intact and unaffected. While the causal relationship models shown in FIGS. 2A-B primary relate to software defined objects for building devices, many different building object relationships may be modeled using the systems and methods of the present disclosure. For example, other building entities (e.g., departments, employees, etc.) may be mapped to the BMS devices or software objects thereof. Therefore, using the causal relationship approach building devices may and the BMS may be linked with other enterprise systems (e.g., an HR management system having employee objects).

Referring again to FIGS. 1C-D, memory 138 is also shown to include hierarchical projection models 154. While the models of the present disclosure are not stored or represented as static hierarchical models, systems and methods of the present disclosure are configured to allow the creation of multiple hierarchical views of the causal relationship model. Each “view” may be defined as a hierarchical model (e.g., tree model, uni-directional tree, top-down tree having a head node) in memory 138 to which a causal relationship model can be applied. In other words, one or more hierarchical models may be created in memory 138 and one or more causal relationships can be projected onto the one or more hierarchical models.

Memory 138 is also shown to include client services 146 configured to allow interaction between internal or external clients or applications and BMS controller 12. Client services 146, for example, may include web services or application programming interfaces available for communication by UI clients 16 and remote applications 18 (e.g., an energy monitoring application, an application allowing a user to monitor the performance of the BMS, an automated fault detection and diagnostics system, etc.).

Memory 138 further includes user interface module 144. User interface module 144 is configured to generate one or more user interfaces for receiving input from a user. User interface module 144 may be configured to provide, for example, a graphical user interface, a voice driven interface, a text-based interface, or another interface for receiving user input regarding the mapping of BMS inputs to building objects. In an exemplary embodiment, user interface module 144 is an HTML-based application configured to be served by, for example, client services 146 or another web server of BMS controller 12 or another device. User interface module 144 may be configured to prompt a user (e.g., visually, graphically, audibly, etc.) for input regarding building objects 142, building object templates 140, causal relationship models 152 or hierarchical projection models 154. In an exemplary embodiment, user interface module 144 prompts the user to create (or otherwise provides a user interface for creating) a template building object 140. User interface module 144 may also prompt the user to map BMS inputs to the template building object. User interface module 144 may receive and handle the user inputs to initiate the storage of received input mappings. In another exemplary embodiment, user interface module 144 may prompt the user to identify, define, store, modify or delete a causal relationship in causal relationship models 152. For example, a user may use a GUI to create a causal relationship between defined building objects in building objects 142, e.g. relating a conference room object to a VAV box object. User interface module 144 may further be configured to generate and serve graphical user interfaces having information displays of building objects and/or causal relationships. User interface module 144 may also be configured to utilize query engine 156 to query and retrieve information about causal relationships in causal relationship models 152 or via hierarchical projection models 154.

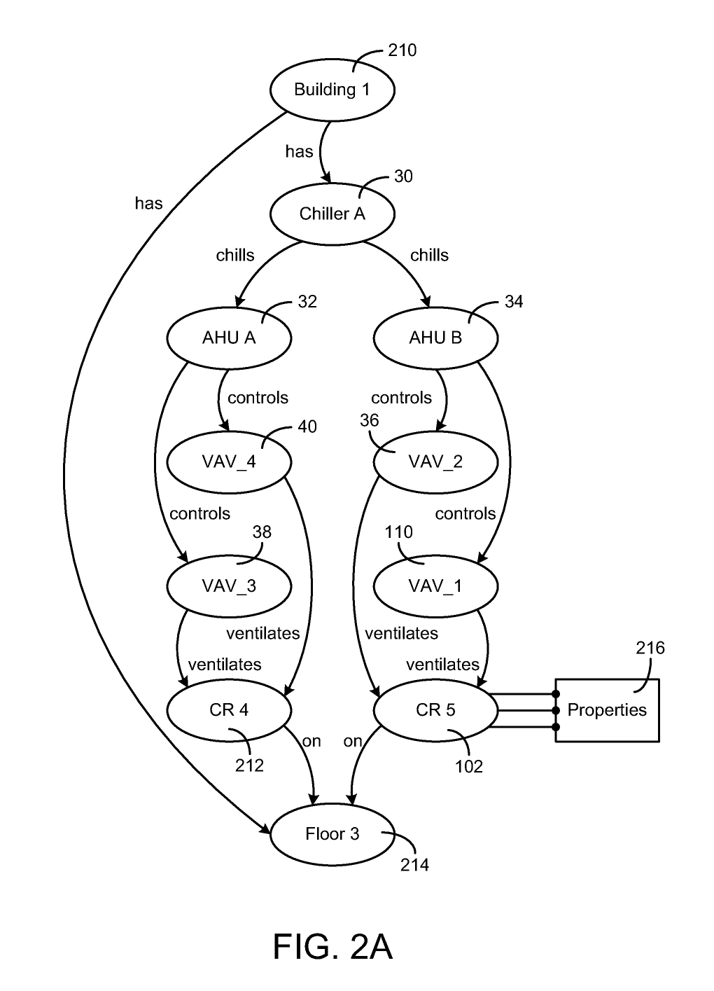

Referring now to FIG. 3, a flow chart of a process 300 for organizing and using information in a building management system (BMS) is shown, according to an exemplary embodiment. Process 300 includes identifying a plurality of building objects (e.g., including building devices, software defined building objects, or other inputs to the BMS that affect the building environment) (step 302). Process 300 also includes identifying the causal relationships between the identified building objects (step 304). Steps 302, 304 may include testing building inputs and outputs for the causal relationships using an automated process. The identifying steps may also or alternatively include using an automated process to analyze characteristics of BMS devices and signals to create software defined building objects and their causal relationships to each other. In yet other exemplary embodiments, the identifying steps include causing a graphical user interface to be displayed that allows a user to input the building objects and the causal relationships between the objects.

Process 300 is further shown to include relating the identified objects by the causal relationships (step 306). Relating the identified objects by causal relationships may be completed by an automated process (e.g., based on testing, based on signal or name analysis at a commissioning phase, etc.) or by user configuration (e.g., of tables, of graphs via a graphical user interface, etc.). In an exemplary embodiment, a graphical user interface may be provided for allowing a user to draw directional links between building objects. Once a link is drawn, a computerized process may cause a dialog box to be shown on the GUI for allowing a user to describe the created causal relationship.

Process 300 is yet further shown to include describing the causal relationships (step 308). The description may be found and stored using any of the previously mentioned processes (e.g., automated via testing, manually input via a keyboard or other user input device, etc.). In one set of exemplary embodiments, the user is able to select (e.g., via a drop down box, via a toolbox, etc.) from a pre-defined list of possible causal relationship descriptions or to insert (e.g., type) a custom causal relationship description at a graphical user interface.

Process 300 is yet further shown to include storing the causal relationships and descriptions in a memory device of the BMS (step 310). The causal relationships may be stored using any of the above-described information structures (e.g., stored in tables, stored as lists linked to object properties, stored as a systems of linked lists, etc.).

Referring again to FIGS. 1C-D, while the causal relationship models of the present disclosure may not be stored or represented as static hierarchical models (e.g., a tag-based hierarchical model description), systems and methods of the present disclosure are configured to allow the creation of multiple hierarchical views of the causal relationship models. Each “view” may be defined as a hierarchical model (e.g., tree model) in memory to which one or more causal relationship models can be applied or projected. For example, at least two different hierarchical models may be used to describe the models of FIGS. 2B-C as shown below:

```
  <Conference Room>
    <VAV Box>
          <AHU>
    <VAV Box/>
  <Conference Room/>
OR
  <AHU>
    <VAV Box>
      <Conference Room/>
    <VAV Box/>
  <AHU>
```

The first example shows a small hierarchical tree of building objects related to a conference room. For example, a conference room may be ventilated by a VAV box, which in turn is controlled by an AHU. In the second example, a similar tree is shown, but from the perspective of an AHU. The AHU may control a VAV box, which in turn ventilates a conference room. Any number or type of hierarchical models may be created and used to describe complex causal relationship models. In conventional systems, a building may only be described using a single static hierarchical tree (e.g., top down, one head node, showing control connections). The present disclosure allows the user or the system to establish many different new information structures by applying desired hierarchical models (e.g., bottom-up, top-down, selecting a new head node, etc.) to the stored causal relationship models. The hierarchical models may be used for reporting, displaying information to a user, for communication to another system or device (e.g., PDA, client interface, an electronic display, etc.), or for further searching or processing by the BMS or the computing system.

Each level of the resultant hierarchical trees may be optionally constrained or not constrained to a certain number of entities (this may be set via by updating one or more variables stored in memory, providing input to a user interface, by coding, or otherwise). In the first hierarchical result shown above, for example, only a single primary VAV box may be specified to be shown for each conference room, even though there may be more VAV boxes associated with the conference room. In an un-constrained hierarchical result, the hierarchical list for each conference room would include all related building objects.

As mentioned above, the BMS controller may be configured to use causal relationship models that may be updated during run time (e.g., by one or more control processes of the system, by user manipulation of a graphical user interface, etc.). Any modification of the causal relationship structure, in such embodiments, may be immediately reflected in applications of hierarchical models. In other words, as the building changes, the BMS controller (with or without the aid of a user) may be configured to update the causal relationship models which in turn will be reflected in the results of applying a hierarchical models to the causal relationships.

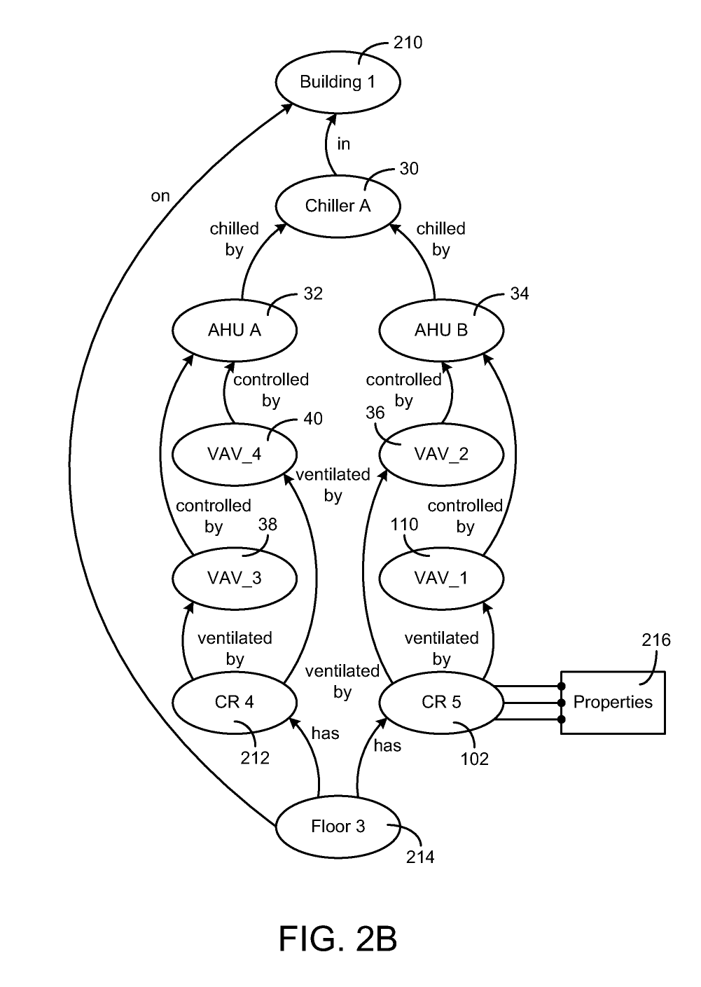

Referring now to FIG. 4, a process 400 for using a hierarchical model of building objects is shown, according to an exemplary embodiment. Process 400 includes defining a hierarchical model of building objects (e.g., such as those shown above or otherwise formatted) (step 402). Process 400 also includes traversing the stored causal relationships to generate a hierarchical result according to the defined hierarchical model (step 404). Alternatively, the hierarchical result may be generated by querying the stored causal relationship. For example, a tree storing causal relationships may be traversed to generate the hierarchical results, whereas a table storing causal relationships may be queried.

Step 404 may be conducted by one or more client applications configured to have access to the causal relationships, by a process of a server whereby only the hierarchical results are provided to client applications, by a process away from the server, or by any other process or module. Process 400 is further shown to include step 406, where the hierarchical result is used to create a graphical representation of the result for display (e.g., at a client, on a report, on a local electronic display system, etc.). A graphical user interface including a tool for allowing a user to define new hierarchical models or to revise a previously defined hierarchical model may further be provided to a user via a display system or client. In step 408 of process 400, at least a portion of the hierarchical result is traversed to generate a report. In step 410 of process 400, the hierarchical result or a group of results may be processed by one or more processing modules, reporting modules, or user interface modules for further analysis of the BMS or for any other purpose (e.g., to further format or transform the results).

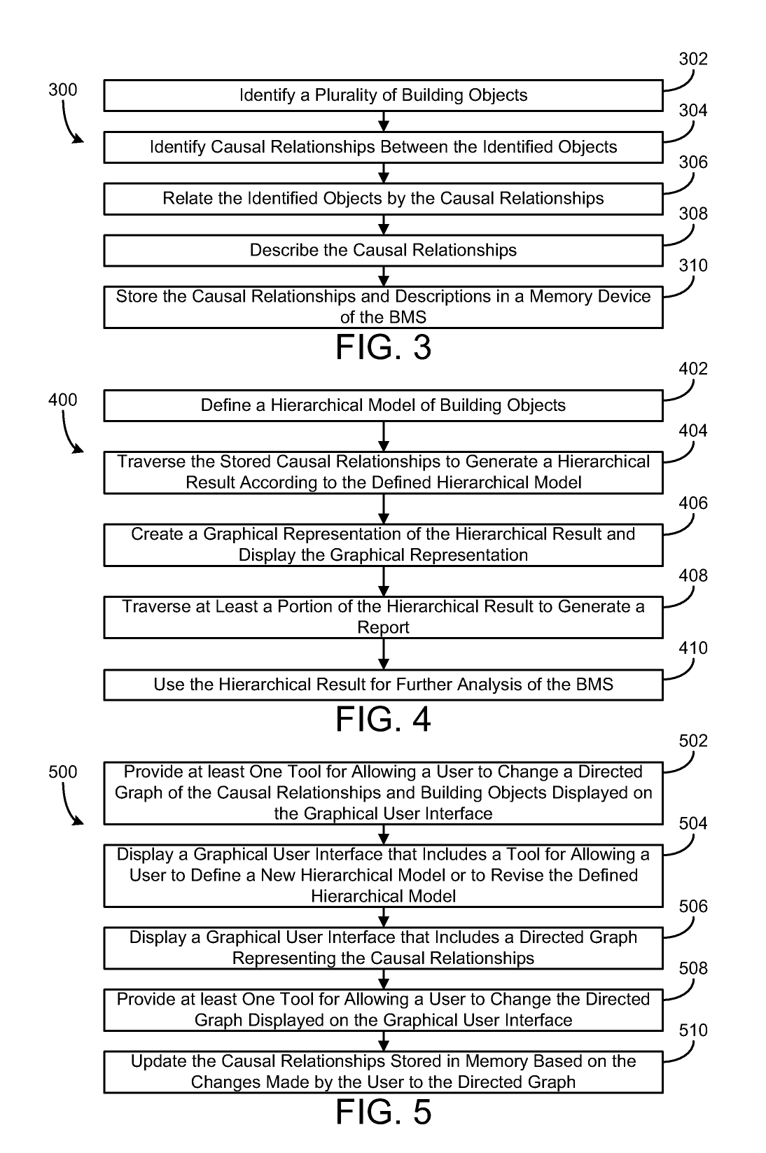

Referring now to FIG. 5, a flow diagram of a process 500 to provide a graphical user interface for allowing users to view or interact with a causal relationship model is shown, according to an exemplary embodiment. Process 500 includes providing at least one tool (e.g., to a graphical user interface, as a text-based interface, etc.) for allowing a user to view or to change a directed graph of the causal relationships and building objects displayed on the graphical user interface (step 502). The tool for changing the directed graph may be the same as the tool for identifying the objects and the relationships elsewhere in the system or process, or may be a different tool for conducting revisions after an initial modeling. Process 500 also includes displaying a graphical user interface that includes a tool for allowing a user to define a new hierarchical model or to revise the hierarchical model (step 504). Process 500 further includes displaying a graphical user interface that includes a directed graph representing the causal relationships (step 506). Process 500 also includes providing at least one tool for allowing a user to change the directed graph displayed on the graphical user interface (step 508). Finally, process 500 includes updating the causal relationships stored in memory based on the changes made by the user to the directed graph (step 510).

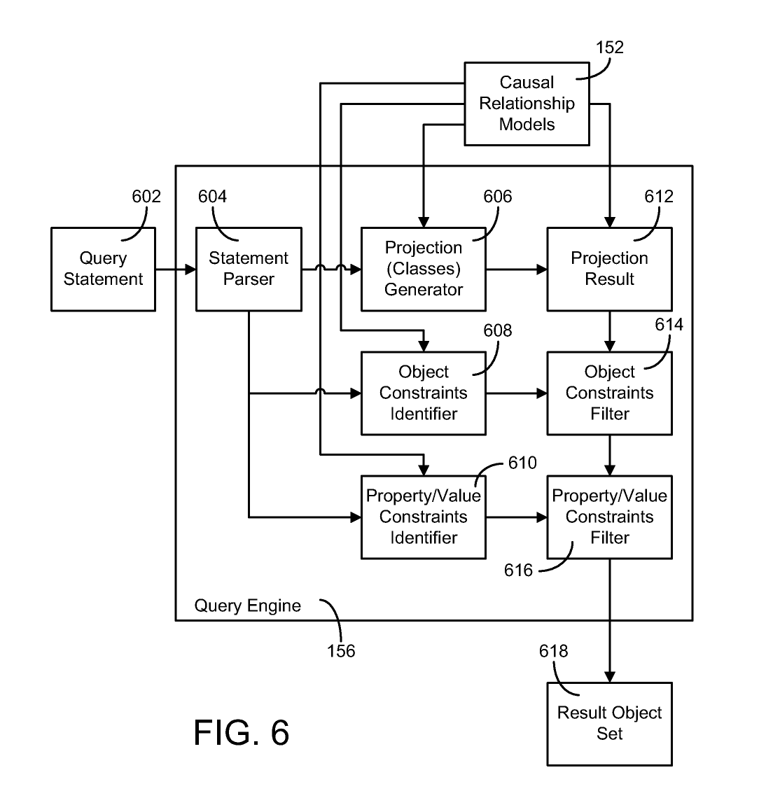

Referring now to FIG. 6, a query engine is shown, according to an exemplary embodiment. Query engine 156 can use the causal relationship and hierarchical projection and methods described above to allow inspection (e.g., querying, searching, etc.) within the graph through structured searches. According to an exemplary embodiment, query statement 602 may be provided to query engine 156 via user interface module 144, client services 146, or application services 148. In this way, a module of the computer system, a client process, or a user via a graphical user interface or another tool (e.g., text-based query engine) may submit a structured query statement 602 to query engine 156. In some embodiments, query engine 156 resides remotely from interface module 144 and from services 146, 148 and communicates with them via middleware 14 over a network. Query engine 156 is configured to receive and parse the structured query statement 602 using statement parser 604. The parsing may seek out key words (e.g., causal relationships, object types, object names, class names, property names, property values, etc.) in query statement 602. Key words that are found may be used by projection generator 606 to construct (e.g., using a computerized process) a hierarchical model for use in conducting a search for relevant objects or for filtering the search via one or more filtering steps. In one exemplary embodiment, parsing of the statement results in: (a) an identification or generation of relevant classes via projection generator 606; (b) an identification of object constraints via object constraints identifier 608; and (c) an identification of property/value constraints via property/value constraints identifier 610. Query engine 156 applies the query aspects identified by projection generator 606, object constraints identifier 608 and property/value constraints identifier 610 to causal relationship models 152 in series to arrive at a result object set 618.

As an example of how query engine 156 operates, an example query statement is given:
“All Conference Rooms on Floor 3 of either Building 1, 2, or 3 with an an Office Temperature of Greater Than 72 Degrees”

Such a statement may be parsed by query engine 156 to:

a) Identify classes of Conference Room, Floor, and Building from the statement using projection generator 606. Using these identified keywords/classes, projection generator 606 may generate a hierarchical model that would provide a structured hierarchical tree of conference rooms, their floors, and their buildings. Query engine 154 may apply the generated hierarchical tree to the one or more causal relationship models 152 to return hierarchical projection results 612 of the conference rooms, floors and buildings, as well as particular properties and values of each object.

b) Identify the object constraints using object constraints identifier 608. Then, using the object constrains identified by object constraints identifier 608, for example, query engine 156 would use object constraints filter 614 to filter the projection results 612 to only those conference rooms with the set of object constraints requested by query statement 602 in their grouping. For example, only those conference rooms on the third floor of Buildings 1, 2, or 3 would remain in a hierarchical result set after filtering using the identified object constraints.

c) Identify the property and value constraints using property/value constraints identifier 610. Then, using the property and value constraints identified by property/value constraints identifier 610, query engine 156 would use property/value constraints filter 616 to filter the hierarchical result set to only those conference rooms with building objects whose temperature is “Greater Than 72 Degrees.”After the object selection and the two filtering steps, the resultant hierarchical data set will be information and context rich for ease of processing and reporting back to the user or for action by one or more computing processes.

Other systems and methods for filtering, searching, and querying may be completed given the causal relationship models and/or hierarchical models to which the causal relationship models can be applied.

The construction and arrangement of the systems and methods as shown in the various exemplary embodiments are illustrative only. Although only a few embodiments have been described in detail in this application, many modifications are possible. For example, the position of elements may be varied and the nature or number of discrete elements or positions may be altered or varied. Accordingly, all such modifications are intended to be included within the scope of the present application. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present application.

The present application contemplates methods, systems and program products on any machine-readable media for accomplishing various operations. The embodiments of the present application may be implemented using existing computer processors, or by a special purpose computer processor for an appropriate system, incorporated for this or another purpose, or by a hardwired system. Embodiments within the scope of the present application include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions. Software implementations could be accomplished with standard programming techniques with rule based logic and other logic to accomplish the various connection steps, processing steps, comparison steps and decision steps.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A computerized method for organizing and using information in a building management system (BMS), comprising:
identifying a plurality of objects comprising building devices, software defined building objects, and other inputs to the BMS that affect a building environment;
identifying causal relationships between the identified objects;
relating the identified objects by the causal relationships;
describing the causal relationships; and
storing the causal relationships and descriptions in a memory device of the BMS.

2. The computerized method of claim 1, wherein the causal relationships are directional and wherein describing the causal relationships comprises describing the direction of the relationship.

3. The computerized method of claim 1, further comprising:
modeling the causal relationships as a directed acyclic graph.

4. The computerized method of claim 1, further comprising:
defining a hierarchical model of building device types, software defined building object types, and other types of inputs to the BMS.

5. The computerized method of claim 4, further comprising:
traversing the stored causal relationships to generate a hierarchical result according to the defined hierarchical model.

6. The computerized method of claim 5, wherein the hierarchical result comprises:
a tagged hierarchical tree of building objects configured for further processing by a process of the BMS, a client device, or another system.

7. The computerized method of claim 5, further comprising:
creating a graphical representation of the hierarchical result; and
displaying the graphical representation of the hierarchical result.

8. The computerized method of claim 5, further comprising:
traversing at least a portion of the hierarchical result to generate a report.

9. The computerized method of claim 5, further comprising:
using the hierarchical result for further analysis of the BMS.

10. The computerized method of claim 5, further comprising:
providing an interface for querying the hierarchical result.

11. The computerized method of claim 5, further comprising:
displaying a graphical user interface that includes at least one tool for allowing a user to at least one of define a new hierarchical model and revise the defined hierarchical model.

12. The computerized method of claim 1, further comprising:
displaying a graphical user interface that includes a directed graph representing the causal relationships.

13. The computerized method of claim 12, further comprising:
providing at least one tool for allowing a user to change the directed graph displayed on the graphical user interface.

14. The computerized method of claim 13, further comprising:
updating the causal relationships stored in memory based on the changes made by the user to the directed graph.

15. The computerized method of claim 1, further comprising:
defining at least one of a template and a class using the stored causal relationships and descriptions.

16. The computerized method of claim 15, further comprising:
applying the template or class to a new set of building devices, software defined objects, or other inputs.

17. The computerized method of claim 1, wherein the identifying steps comprise:
causing a graphical user interface to be displayed that allows a user to input the objects and the causal relationships between the objects.

18. The computerized method of claim 1, wherein the identifying steps comprise:
testing building inputs and outputs for the causal relationships using an automated process.

19. The computerized method of claim 1, wherein the identifying steps comprise:
using an automated process to analyze characteristics of BMS devices and signals to create software defined building objects and their causal relationships to each other.

20. A computer system for organizing and using information in a building management system (BMS), comprising:
a memory device storing software defined building objects; and
a processing circuit configured to relate the software defined building objects by causal relationships between the devices and to store the causal relationships and a description of the causal relationships in the memory device.
